(19) United States
(12) Patent Application Publication
(10) Pub. No.: US 2012/0115715 A1
(43) Pub. Date: May 10, 2012

(54) METHOD FOR PRODUCING A SUPPORTED METAL NITRATE

(75) Inventors: Mariska Wolters, Lelystad (NL); Peter Munnik, Bilthoven (NL); Johannes Hendrik Bitter, Odijk (NL); Petra Elisabeth De Jongh, Utrecht (NL); Krijn Pieter De Jong, Houten (NL)

(73) Assignee: Johnson Matthey PLC, London (GB)

(21) Appl. No.: 13/258,846

(22) PCT Filed: Mar. 11, 2010
(86) PCT No.: PCT/GB10/50430

§ 371 Date: Jan. 11, 2012

(30) Foreign Application Priority Data
Mar. 26, 2009 (GB) 0905222.6

(51) Int. Cl. B01J 37/08; B01J 37/16; B01J 37/18; B01J 20/02; B01J 23/72; B01J 23/755; B01J 23/75; B01J 20/32; B01J 21/08; B01J 35/02

(52) U.S. Cl. 502/240; 502/300; 502/345; 502/337; 502/325; 502/400; 502/407; 502/406

(57) ABSTRACT

A method for the preparation of a supported metal nitrate, suitable as a precursor for a catalyst or sorbent, includes the steps of:
(i) impregnating a support material with a metal nitrate,
(ii) optionally drying the impregnated material at low temperature, and
(iii) exposing the impregnated material to a gas mixture comprising nitric oxide at a temperature in the range 0-150° C., to form a dispersed supported metal nitrate.

The metal nitrate may subsequently be converted to the corresponding oxide by calcining the metal nitrate to effect its decomposition. Preferred metals are iron, ruthenium, cobalt, rhodium, iridium, nickel, palladium, platinum, copper or a mixture thereof.

### CROSS-REFERENCE TO RELATED APPLICATIONS

This application is the U.S. National Phase application of PCT International Application No. PCT/GB2010/050430, filed Mar. 11, 2010, and claims priority of British Patent Application No. 0905222.6, filed Mar. 26, 2009, the disclosures of both of which are incorporated herein by reference in their entireties for all purposes.

### FIELD OF THE INVENTION

This invention relates to making supported metal nitrates suitable for use as precursors of catalysts or sorbents.

### BACKGROUND OF THE INVENTION

Metal nitrates are useful catalyst or sorbent precursors due to their relatively low cost and ease of manufacture. In catalyst or sorbent manufacture, typically one or more soluble metal nitrates is impregnated onto a suitable support material, and dried to remove the solvent. The impregnated support is then usually heated under air, in a step often called calcination, to an elevated temperature at or above the decomposition temperature of the metal nitrate to form the metal oxide. However, such a method does not always lead to satisfactory oxidic materials. In particular, where the metal oxide is a reducible metal oxide, the dispersion and distribution of crystallites of the metal oxide and hence reduced metal obtained by these processes is often poor.

Improved calcination measures have been published. WO 2007/071899 discloses a calcination procedure for converting metal nitrates into the corresponding metal oxides by heating the metal nitrate to effect its decomposition under a gas mixture containing nitric oxide (NO) and having an oxygen content of <5% by volume. WO 2008/029177 discloses an identical method using nitrous oxide (N₂O). Whereas these documents consider the high temperature conversion of the nitrate to the oxide they do not consider the effect of exposing the supported metal nitrate to gases at temperatures below that at which the oxide forms.

### SUMMARY OF THE INVENTION

We have found that by using a low temperature thermal treatment on the dried or un-dried metal nitrate, improved metal dispersion may be achieved. Increased metal dispersion is desirable, as catalytic activity or sorbency is often positively related to the surface area of the resulting metal compounds on the support.

Accordingly the invention provides a method for the preparation of a supported metal nitrate, suitable as a precursor for a catalyst or sorbent, comprising the steps of:
(i) impregnating a support material with a metal nitrate, and
(ii) exposing the impregnated material to a gas mixture comprising nitric oxide at a temperature in the range 0-150° C., to form a dispersed supported metal nitrate.

The invention further provides a supported metal nitrate obtainable by the above method.

### BRIEF DESCRIPTION OF THE DRAWINGS

The invention is also illustrated by reference to the Examples and by reference to FIGS. 1-4, in which;

FIG. 1 depicts transmission electron micrographs of silica supported CuO (A-1, B-1),

FIG. 2 depicts HAADF-STEM image of silica supported copper nitrate (Sample D),

FIG. 3 depicts bright-field STEM image of silica supported CuO (D-1, D-2),

FIG. 4a depicts the normalized peak area of the Cu₂(OH)₃NO₃ and CuO diffraction lines derived from in-situ XRD analysis during heating as a function of temperature, and

FIG. 4b depicts the XRD diffraction lines at 120° C. for both thermal treatments.

### DETAILED DESCRIPTION OF THE INVENTION

Thus unlike the methods disclosed in the aforesaid WO 2007/071899 and WO 2008/029177, the method of the present invention acts to stabilise the nitrate and reduce its tendency to agglomerate on the support surface.

The metal nitrate may be supported in a number of ways including molten nitrate impregnation, i.e. impregnation using a molten metal nitrate, or by impregnation using a suitable solution of the metal nitrate. For example the metal nitrate may be impregnated onto a support material from an aqueous or non-aqueous solution, e.g. ethanol or acetone, which may include other solvents. One or more metal nitrates may be present in the solution. One or more impregnation steps may be performed to increase metal loading or provide sequential layers of different metal nitrates prior to drying. Impregnation may be performed using any of the methods known to those skilled in the art of catalyst or sorbent manufacture, but preferably is by way of a so-called ‘dry’ or ‘incipient-wetness’ impregnation as this minimises the quantity of solvent used and to be removed in subsequent drying. Incipient wetness impregnation is particularly suitable for porous support materials and comprises mixing the support material with only sufficient liquid to fill the pores of the support.

Typically the impregnation is performed until the metal content of the impregnated material (calculated on a dry basis) is in the range 1-30% by weight.

In the present invention, the impregnated material is exposed to a gas mixture comprising nitric oxide at a temperature in the range 0-150° C. preferably 10-120° C., more preferably 25-75° C., to form a dispersed supported metal nitrate.

Thus in one embodiment this exposure results in the removal of solvent from the impregnated material, i.e. the treatment serves to simultaneously dry and stabilise the metal nitrate on the support. In an alternative embodiment, if desired, an additional drying step may be performed at low temperature prior to exposure to the NO-containing gas mixture to remove solvent. If this additional step is performed it should be carried out at temperatures below 60° C., e.g. in the range 0 to 60° C., under vacuum or air or under an inert gas such as nitrogen so not as to cause agglomeration of the metal nitrate. Accordingly, the impregnated material should desirably be kept below about 60° C. prior to the exposure to the NO-containing gas mixture.

The impregnated material may therefore be dried under the NO-atmosphere or alternatively dried at low temperature below about 60° C. under vacuum, air or an inert atmosphere to remove solvent and then heated under the nitric oxide atmosphere to remove any remaining solvent and form a stabilised metal nitrate.

It may be desirable, particularly when the thermal treatment is performed above about 20° C., that the atmosphere to which the supported metal nitrate is exposed during heating contains very little or no free oxygen as this has been found to be a source of reduced metal oxide dispersion in nitrate-derived materials. Hence the oxygen (O₂) content of the gas stream is preferably ≦55%, more preferably ≦51%, most preferably ≦50.1% by volume.

The gas stream to which the metal nitrate is exposed may be any gas stream that contains nitric oxide. Preferably the gas stream comprises nitric oxide and one or more gases selected from carbon monoxide, carbon dioxide or an inert gas. Preferably the inert gas is one or more selected from nitrogen, helium or argon. Preferably the gas stream to which the supported metal oxide is exposed consists of one or more inert gases and nitric oxide.

The gas mixture to which the supported metal nitrate is exposed may be at or above atmospheric pressure, typically up to about 10 bar abs. Various methods, known in the art for performing the heating step may be used. Where the heating step is performed by passing the gas mixture through a bed of the supported metal nitrate, the gas-hourly-space-velocity (GHSV) of the gas mixture is preferably in the range of 100-600000 h⁻¹.

The nitric oxide concentration in the gas stream is preferably in the range 0.001 to 15% by volume, more preferably 0.1 to 15% vol, most preferably 1 to 10% vol to achieve the desired effect at a scalable space velocity and at the same time minimise scrubbing requirements.

The supported metal nitrate comprises one or more metal nitrates on the surface and/or in the pores of the support. The metal nitrate may be any metal nitrate but is preferably a nitrate of a metal used in the manufacture of catalysts, catalyst precursors or sorbents. The metal nitrate may be an alkali-, alkali metal- or transition metal-nitrate. Preferably the metal nitrate is a transition metal nitrate, i.e. a nitrate of metals selected from Groups 3-12 inclusive of the Periodic Table of the Elements. Suitable readily available metal nitrates for catalyst, catalyst precursor or sorbent manufacture include nitrates of La, Ce, Zr, Cr, Mn, Fe, Ru, Co, Rh, Ir, Ni, Pd, Pt, Cu and Zn, more preferably nitrates of Cr, Mn, Fe, Ru, Co, Rh, Ir, Ni, Pd, Pt, Cu and Zn. One or more metal nitrates may be present. By the term “metal nitrate” we include metal nitrate compounds of formula M(NO₃)ₓ.(H₂O)ₐ where x is the valency of the metal M, and ‘a’ may be 0 or an integer ≧1.

However, the present invention has been found to be of particular use where the resulting supported metal nitrate product comprises a metal nitrate of formula Mₓ(OH)_{y}(NO₃)_{z} in which x, y and z are integers ≧1 and M is a transition metal, preferably iron, ruthenium, cobalt, rhodium, iridium, nickel, palladium, platinum, copper or a mixture thereof, more preferably copper, nickel or cobalt, especially copper. Thus the metal nitrate solution preferably comprises a nitrate of iron, ruthenium, cobalt, rhodium, iridium, nickel, palladium, platinum, copper or a mixture thereof, more preferably copper, nickel or cobalt, especially copper. Other metal nitrates may be present.

The support onto which the metal nitrate may be supported may be a metal, carbon, metal oxide, mixed metal oxide or solid polymer support.

Carbon supports, such as activated carbons, high surface area graphites, carbon nanofibres, and fullerenes in powder, pellet or granular form and having suitable porosities, e.g. above 0.1 ml/g may be used as supports for the present invention, preferably where the gas stream contains ≦0.1% oxygen by volume.

Preferably the support is an oxidic support, which may be a single- or mixed metal oxide material, including ceramics, zeolites, perovskites, spinels and the like. The oxidic support may also be in the form of a wash-coat on a ceramic, metal, carbon or polymer substrate.

The support may be in the form of a powder having a surface-weighted mean diameter D[3,2] in the range 1 to 200 microns. The term surface-weighted mean diameter D[3,2], otherwise termed the Sauter mean diameter, is defined by M. Alderliesten in the paper “A Nomenclature for Mean Particle Diameters”; Anal. Proc., vol 21, May 1984, pages 167-172, and is calculated from the particle size analysis, which may conveniently be effected by laser diffraction for example using a Malvern Mastersizer. Agglomerates of such powders having particle sizes in the range 200 microns to 1 mm may also be used as the support. Alternatively the support may be in the form of shaped units such as pellets, extrudates or granules typically having particle sizes in the range 1-25 mm and an aspect ratio of less than 2. (By particle size we mean the smallest particle dimension such as width, length or diameter). Alternatively the support may be in the form of a monolith, e.g. a honeycomb, or a cellular material such as an open foam structure.

The support is preferably selected from alumina, metal-aluminate, silica, aluminosilicate, zinc oxide, titania, zirconia or mixtures of these, including co-gels, either in powder, shaped unit, monolithic or cellular form.

The support may be a silica support. Silica supports may be formed from natural sources, e.g. as kieselguhr, may be a pyrogenic or fumed silica or may be a synthetic, e.g. precipitated silica or silica gel. Structured mesoporous silicas, such as SBA-15 may be used as a support. Precipitated silicas may also be used. The silica may be in the form of a powder or a shaped material, e.g. as extruded, pelleted or granulated silica pieces. Suitable powdered silicas typically have particles of surface weighted mean diameter D[3,2] in the range 3 to 100 μm. Shaped silicas may have a variety of shapes and particle sizes, depending upon the mould or die used in their manufacture. For example the particles may have a cross-sectional shape which is circular, lobed or other shape and a length from about 1 to greater than 10 mm. The BET surface area of suitable powdered or granular silicas is generally in the range 10-500 m²/g, preferably 100-400 m²g⁻¹. The pore volume is generally between about 0.1 and 4 ml/g, preferably 0.2-2 ml/g and the mean pore diameter is preferably in the range from 0.4 to about 30 nm. If desired, the silica may be mixed with another metal oxide, such as titania or zirconia. The silica may alternatively be present as a coating on a shaped unit, which is preferably of alumina typically as a coating of 0.5 to 5 monolayers of silica upon the underlying support.

The support may be zinc oxide, which is preferably a high surface area material. The zinc oxide may also be part of a mixed oxide e.g. zinc-titanate.

The support may be a titania support. Titania supports are preferably synthetic, e.g. precipitated titanias. The titania may optionally comprise e.g. up to 20% by weight of another refractory oxide material, typically silica, alumina or zirconia. The titania may alternatively be present as a coating on a support which is preferably of silica or alumina, for example as a coating of 0.5 to 5 monolayers of titania upon the underlying alumina or silica support. The BET surface area of suitable titania is generally in the range 10-500 m²/g, preferably 100 to 400 m²/g. The pore volume of the titania is preferably between about 0.1 and 4 ml/g, more preferably 0.2 to 2 ml/g and the mean pore diameter is preferably in the range from 2 to about 30 nm.

Similarly zirconia supports maybe synthetic, e.g. precipitated zirconias. The zirconia may again optionally comprise e.g. up to 20% by weight of another refractory oxide material, typically silica, alumina or titania. Alternatively the zirconia may be stabilised e.g. an yttria- or ceria-stabilised zirconia. The zirconia may alternatively be present as a coating on a support, which is preferably of silica or alumina, for example as a coating of 0.5 to 5 monolayers of zirconia upon the underlying alumina or silica support.

The support may be a metal aluminate, for example a calcium aluminate.

The support material may be a transition alumina. Transition aluminas are defined in “Ullmans Encyklopaedie der technischen Chemie”, 4., neubearbeitete and erweiterte Auflage, Band 7 (1974), pp. 298-299. Suitable transition alumina may be of the gamma-alumina group, for example eta-alumina or chi-alumina. These materials may be formed by calcination of aluminium hydroxides at 400 to 750° C. and generally have a BET surface area in the range 150 to 400 m²/g. Alternatively, the transition alumina may be of the delta-alumina group which includes the high temperature forms such as delta- and theta-aluminas which may be formed by heating a gamma group alumina to a temperature above about 800° C. The delta-group aluminas generally have a BET surface area in the range 50 to 150 m²/g. Alternatively, the transition alumina may be alpha-alumina. The transition aluminas contain less than 0.5 mole of water per mole of Al₂O₃, the actual amount of water depending on the temperature to which they have been heated. A suitable transition alumina powder generally has a surface-weighted mean diameter D[3,2] in the range 1 to 200 μm. In certain applications such as for catalysts intended for use in slurry reactions, it is advantageous to use very fine particles which are, on average, preferably less than 20 μm, e.g. 10 μm or less. For other applications e.g. as a catalyst for reactions carried out in a fluidised bed, it may be desirable to use larger particle sizes, preferably in the range 50 to 150 μm. It is preferred that the alumina powder has a relatively large average pore diameter as the use of such aluminas appears to give catalysts of particularly good selectivity. Preferred aluminas have an average pore diameter of at least 10 nm, particularly in the range 15 to 30 nm. [By the term average pore diameter we mean 4 times the pore volume as measured from the desorption branch of the nitrogen physisorption isotherm at 0.98 relative pressure divided by the BET surface area]. Preferably, the alumina material is a gamma alumina or a theta alumina, more preferably a theta alumina, having a BET surface area of 90-120 m²/g and a pore volume of 0.4-0.8 cm³/g. The alumina support material may be in the form of a spray dried powder or formed into shaped units such as spheres, pellets, cylinders, rings, or multi-holed pellets, which may be multi-lobed or fluted, e.g. of cloverleaf cross-section, or in the form of extrudates known to those skilled in the art. The alumina support may be advantageously chosen for high filterability and attrition resistance.

The present invention may be used to convert metal nitrates on any support material, however, certain metal nitrate/support combinations are more preferred. For example, depending upon the metal it may be, or may not be, desirable to combine the metal nitrate with a support that is able, under the heating conditions used to decompose the metal nitrate, form mixed metal oxide compounds with the resulting supported metal oxide. Low-activity supports such as carbon or alpha-alumina may be used to reduce or prevent mixed-metal oxide formation with the support where this is undesired.

The supported metal nitrates obtained by the process of the present invention contain small crystallites, typically ≦10 nm in size, of metal nitrate of formula M(NO₃)ₓ.(H₂O)ₐ where x is the valency of the metal M and a is an integer ≧1, and/or preferably Mₓ(OH)_{y}(NO₃)_{z} in which x, y and z are integer ≧1. As stated above, M is preferably iron, ruthenium, cobalt, rhodium, iridium, nickel, palladium, platinum, copper or a mixture thereof, preferably copper, nickel or cobalt, especially copper.

The supported metal nitrate may be converted into a highly dispersed supported metal oxide by calcining the supported metal nitrate. This may be carried out using conventional calcination methods in air at temperatures in the range 200-1200° C., preferably 200-800° C., more preferably 250-450° C. Preferably, calcination is carried out using the nitric oxide or nitrous oxide calcination methods of WO 2007/071899 and WO 2008/029177 in order to better preserve the metal dispersion. Alternatively calcination in the presence of hydrogen or carbon monoxide under conditions where reduction does not take place may also be used to produce supported metal oxide materials with low residual nitrate levels. Thus preferably the calcination is performed under a gas mixture that contains nitric oxide, nitrous oxide, hydrogen or carbon monoxide or a mixture thereof and has an oxygen content of ≦5% by volume to bring about its decomposition by heating it to, or if desired above, its decomposition temperature at which it forms the metal oxide. The oxygen (O₂) content of the gas stream is preferably ≦1%, most preferably ≦0.1% by volume. The temperature to which the metal nitrate may be raised to bring about its decomposition may be in the range 100-1200° C., but preferably the temperature is in the range 200-600° C. to ensure conversion of the nitrate to the oxide while at the same time minimising sintering of the oxide. It has been found that smaller metal oxide crystallites may be obtained by calcination at lower temperatures in this range, e.g. between 200 and 450° C. However, where it is desired to form spinel or perovskite oxide phases on or with the support, it may be desirable to use temperatures in the range 500-1200° C. The time at which the supported metal nitrate is at a temperature within these ranges range is preferably ≦16 hours, more preferably ≦8 hours. Short calcination times, e.g. ≦4 hours, particularly ≦2 hours, are most preferred. Using such techniques at least 90% wt, more preferably at least 95%, most preferably at least 99% of the metal nitrate is desirably converted into the corresponding metal oxide.

Accordingly the invention further provides a supported oxide obtainable by (i) impregnating a support material with a metal nitrate, (ii) exposing the impregnated material to a gas mixture comprising nitric oxide at a temperature in the range 0-150° C., to form a dispersed supported metal nitrate, and (iii) calcining the metal nitrate to effect its decomposition and form a supported metal oxide.

The supported metal oxides have smaller metal oxide crystallite sizes and therefore a higher metal oxide dispersion than the metal oxide obtainable using prior art methods. This is because the stabilisation of the metal nitrate at low temperature before the conversion to the metal oxide, e.g. during drying, and is especially the case where calcination is effected using nitric and or nitrous oxide gas mixtures, by the cumulative effect of these. The supported metal oxides of the present invention have been found by Scanning Transmission Electron Microscopy (STEM) and X-Ray Diffraction (XRD) to have metal oxide crystallite sizes ≦10 nanometres, preferably ≦6 nanometres at resulting metal oxide loadings on the supports of up to 30% by weight.

Where the metal oxide is a reducible metal oxide, such as an oxide of copper, nickel, iron or cobalt, the process may further comprise a step of heating the supported metal oxide under a reducing gas stream containing carbon monoxide and/or hydrogen to effect reduction of at least a part of the metal oxide.

Alternatively, where the metal nitrate is a reducible metal nitrate, such as a nitrate of copper, nickel, iron or cobalt, it may not be necessary or desirable to calcine the material but subject it directly to a reduction step with a reducing gas stream, in a so-called direct reduction. In the present invention the higher metal dispersion achievable from the low-temperature treatment with nitric oxide, makes direct reduction particularly attractive. Thus in a preferred embodiment, where the metal nitrate is a reducible metal nitrate, the process further comprises a step of heating the supported metal nitrate under a reducing gas stream containing carbon monoxide and/or hydrogen to effect reduction of at least a part of the metal nitrate.

Accordingly the invention further provides a supported reduced metal nitrate or oxide obtainable by (i) impregnating a support material with a metal nitrate, (ii) exposing the impregnated material to a gas mixture comprising nitric oxide at a temperature in the range 0-150° C., to form a dispersed supported metal nitrate, (iii) optionally calcining the metal nitrate to effect its decomposition and form a supported metal oxide, and (iv) heating the supported metal oxide or supported metal nitrate under a reducing gas stream containing carbon monoxide and/or hydrogen to effect reduction of at least a part of the metal nitrate or oxide.

A supported reduced metal composition prepared in this way will comprise a metal in the elemental form, and possibly small amounts of unreduced metal oxide or nitrate, on the support material. In addition, other, reducible or non-reducible metal oxides may be present on the support.

The reduction step may be performed by passing a hydrogen-containing gas such as hydrogen, synthesis gas or a mixture of hydrogen with nitrogen, methane or other inert gas over the supported reducible metal oxide or nitrate at elevated temperature, for example by passing the hydrogen-containing gas over the composition at temperatures in the range 150-600° C., preferably 300-500° C. for between 0.1 and 24 hours, at atmospheric or higher pressures up to about 25 bar. The optimum reducing conditions for nickel oxide, cobalt oxide, copper oxide or iron oxides are known to those skilled in the art.

In the supported reduced metal oxide or nitrate prepared by the method of the present invention preferably at least 70%, more preferably >80% and most preferably >90% of the reducible metal is reduced to the elemental active form. Reduced metal oxides with very high metal dispersions, expressed as metal surface area per gram catalyst or gram metal in the reduced material may be obtained by the method of the present invention. Metal surface areas may conveniently be determined by chemisorption (e.g. hydrogen chemisorption) using methods known to those skilled in the art.

Reduced oxides or nitrates contain highly dispersed metal and therefore oxidation by exposure to air may lead to undesirable self-heating as a result of the exothermic oxidation reactions. Such self-heating may lead to high temperatures in excess of 250° C. and the consequential sintering of the metal and loss of surface area. To prevent this, and to ease handling, it is desirable to passivate the reduce material following the reduction step by treatment with gas mixtures containing air and or carbon dioxide. Such methods are described for example in U.S. Pat. No. 4,090,980, GB 1319622 and WO 95/33644.

The supported metal oxides and supported reduced metal oxides or nitrates may be used in many fields of technology. Such areas include catalyst, catalyst precursors, sorbents, semi-conductors, superconductors, magnetic storage media, solid-state storage media, pigments and UV-absorbents. Preferably, the supported metal oxides and supported reduced metal oxides or nitrates are used as catalysts, catalyst precursors or sorbents. By the term “sorbents” we include adsorbents and absorbents.

In preferred embodiments, the supported metal oxides and supported reduced metal oxides or nitrates are used a catalyst precursors or catalysts in methanol synthesis, water-gas shift, hydrogenation reactions, steam reforming reactions, methanation reactions and the Fischer-Tropsch synthesis of hydrocarbons. For example, reduced supported Cu materials such as Cu/ZnO/Al₂O₃ are used as methanol synthesis catalysts and water-gas shift catalysts. Reduced supported Ni, Cu and Co oxides may be used alone or in combination with other metal oxides as catalysts for hydrogenation reactions and the reduced Fe or Co oxides may be used as catalysts for the Fischer-Tropsch synthesis of hydrocarbons. Ni and Co catalysts find use in hydrodesulphurisation. Reduced Fe catalysts may be used in high-temperature shift reactions and in ammonia synthesis. Reduced Ni and precious metal catalysts find use as steam reforming catalysts and as methanation catalysts. Oxidic Co catalysts find use in oxidation reactions including ammonia oxidation and N₂O destruction. Oxidic Ni catalysts may be used for the decomposition of hypochlorite in aqueous solutions.

Typical hydrogenation reactions include the hydrogenation of aldehydes and nitriles to alcohols and amines respectively, and the hydrogenation of cyclic aromatic compounds or unsaturated hydrocarbons. The catalysts of the present invention are particularly suitable for the hydrogenation of unsaturated organic compounds particularly oils, fats, fatty acids and fatty acid derivatives like nitriles. Such hydrogenation reactions are typically performed in a continuous or batch-wise manner by treating the compound to be hydrogenated with a hydrogen-containing gas under pressure in an autoclave at ambient or elevated temperature in the presence of the catalyst, for example the hydrogenation may be carried out with hydrogen at 80-250° C. and a pressure in the range 0.1-5.0×10⁶ Pa.

The Fischer-Tropsch synthesis of hydrocarbons is well established. The Fischer-Tropsch synthesis converts a mixture of carbon monoxide and hydrogen to hydrocarbons. The mixture of carbon monoxide and hydrogen is typically a synthesis gas having a hydrogen: carbon monoxide ratio in the range 1.7-2.5:1. The reaction may be performed in a continuous or batch process using one or more stirred slurry-phase reactors, bubble-column reactors, loop reactors or fluidised bed reactors. The process may be operated at pressures in the range 0.1-10 Mpa and temperatures in the range 150-350° C. The gas-hourly-space-velocity (GHSV) for continuous operation is in the range 100-25000 hr⁻¹. The catalysts of the present invention are of particular utility because of their high metal surface areas/g catalyst.

In steam reforming a hydrocarbon, typically a methane-containing gas such as natural gas, or naphtha is reacted with steam and/or, where appropriate, carbon dioxide, over a catalytically active material to produce a gas containing hydrogen and carbon oxides. These reactions are strongly endothermic and the process is especially suitable when they are carried out with external heating as in tubular steam reforming. Alternatively the heat can be supplied by heating the reactants and passing steam over the catalyst in an adiabatic bed or in a hybrid process in which oxygen is a reactant, so that heat evolved in oxidation is absorbed by the endothermic reactions. The hybrid process can be applied to the product of the tubular or adiabatic process that is, in “secondary reforming”, or to fresh feedstock (“catalytic partial oxidation” or “autothermal reforming”). Commonly these reactions are accompanied by the water-gas shift reaction. For the production of hydrogen-containing synthesis gas, the outlet temperature is preferably at least 600° C. to ensure low methane content. While the temperature is generally in the range 750-900° C. for making synthesis gas for ammonia or methanol production, it may be as high as 1100° C. for the production of metallurgical reducing gas, or as low as 700° C. for the production of town gas. For the hybrid process using oxygen, the temperature may be as high as 1300° C. in the hottest part of the catalyst bed.

In pre-reforming, a hydrocarbon/steam mixture is subjected to a step of adiabatic low temperature steam reforming. In such a process, the hydrocarbon/steam mixture is heated, typically to a temperature in the range 400-650° C., and then passed adiabatically through a fixed bed of a suitable particulate catalyst, usually a catalyst having a high nickel content, for example above 40% by weight. The catalysts may be simple cylinders of a multiholed, lobed shape. Pre-reforming catalysts are typically provided in a pre-reduced and passivated form, although oxidic catalyst may also be installed. During such an adiabatic low temperature reforming step, any hydrocarbons higher than methane react with steam to give a mixture of methane, carbon oxides and hydrogen. The use of such an adiabatic reforming step, commonly termed pre-reforming, is desirable to ensure that the feed to the steam reformer contains no hydrocarbons higher than methane and also contains a significant amount of hydrogen. This is desirable in order to minimise the risk of carbon formation on the catalyst in the downstream steam reformer.

For steam reforming reactions the catalyst usually comprises metallic nickel on an alumina, zirconia or calcium aluminate support. The pressure is typically in the range 1-50 bar abs. but pressures up to 120 bar abs. are proposed. An excess of steam and/or carbon dioxide is normally used, especially in the range 1.5 to 6, for example 2.5 to 5, mols of steam or carbon dioxide per gram atom of carbon in the starting hydrocarbon.

Where the Ni catalyst is to be used for methanation, in order to remove low concentrations of CO and CO₂ (0.1-0.5% vol) from a hydrogen-containing gas, the hydrogen-containing gas is typically passed through a particulate fixed bed at a temperature in the range 230-450° C. and pressures up to about 50 bar abs or higher up to about 250 bar abs. Unlike steam reforming the catalyst are preferably simple cylindrical pellets without through holes, although such pellets may be used if desired. Typical pellet diameters are in the range 2.5-5 mm, with lengths in the same range. The catalysts may be provided in oxidic form or pre-reduced and passivated form.

Sorbent compositions comprising Cu and/or Zn compounds may be used in sulphur-compound removal from gaseous or liquid streams, particularly hydrocarbon streams and synthesis gas streams. The sulphur-compound removal may be performed simply by passing the sulphur-compound-containing stream over a fixed bed of the sorbent in a suitable vessel at temperatures in the range 0-300° C. at atmospheric or elevated pressures, e.g. up to 100 bar abs.

Sorbent compositions comprising suiphided transition metal compounds, particularly compositions comprising suiphided copper compounds, may be used for removal of heavy metals such as Hg or As from contaminated gaseous or liquid streams. The heavy metal removal may be performed simply by passing the heavy-metal-containing stream over a fixed bed of the sorbent in a suitable vessel at temperatures in the range 0-100° C. at atmospheric or elevated pressures, e.g. up to 100 bar abs.

The sulphur-compounds and heavy metal compound removal steps may be preformed sequentially or simultaneously.

### EXAMPLES

### Example 1

### SBA-15 Supported Copper Oxide

An incipient wetness impregnation step was performed at 60 mbar with a 4.3 M aqueous copper (II) nitrate (Cu(NO₃)₂.6H₂O) solution on 0.25 g SBA-15 powder (BET surface area=600 m²/g, total pore volume=0.7 cm³/g) to provide 16 wt % Cu/SiO₂. After an equilibration time of 15 minutes, two different routes were taken. A first sample was directly transferred to a plug flow reactor (diameter 1 cm, length 17 cm) and subjected to a combined low and high temperature thermal treatment in 1% NO/Ar or air according to Table 1. A second sample was first dried at 120° C. in static air for 12 hours before being subjected to same thermal treatments in 1% NO/Ar or air. In each case the sample weight was 100 mg.

The samples treated in 1% NO by volume in Ar were designated as A-1 and B-1, while samples treated in air were designated A-2 and B-2.

TABLE 1
Temperature and gas flow thermal treatment

| | | | | Heating | | NO/Ar/N₂* |
|---|---|---|---|---|---|---|
| | Duration | Tₛₜₐᵣₜ | T_{final} | rate | N₂ | or air |
| Step N^{o} | (min) | (° C.) | (° C.) | ° C./min | (ml/min) | (ml/min) |
| 1 | 10 | 25 | 25 | 0 | 100 | 0 |
| 2 | 35 | 25 | 60 | 1 | 0 | 100 |
| 3 | 60 | 60 | 60 | 0 | 0 | 100 |
| 4 | 340 | 60 | 400 | 1 | 0 | 100 |
| 5 | 30 | 400 | 400 | | 0 | 100 |
| 6 | 40 | 400 | 25 | −10 | 100 | 0 |

*1% v/v NO, 9% v/v Ar, 90% N₂

Sample A-1 was prepared according to the present invention, using a low-temperature thermal treatment in the NO-containing gas before the high temperature thermal treatment. Samples A-2 and B-2 are comparative samples. Characterization was performed by X-ray powder diffraction (XRD) and transmission electron microscopy (TEM). XRD patterns were obtained at room temperature from 35° to 70° 2θ with a Bruker-Nonius D8 Advance X-ray diffractometer set-up using Co-K_{α12} (λ=1.79026 Å) radiation. The average copper oxide particle sizes were calculated according to the Scherrer equation, using the most intense diffraction line at 45.3°.

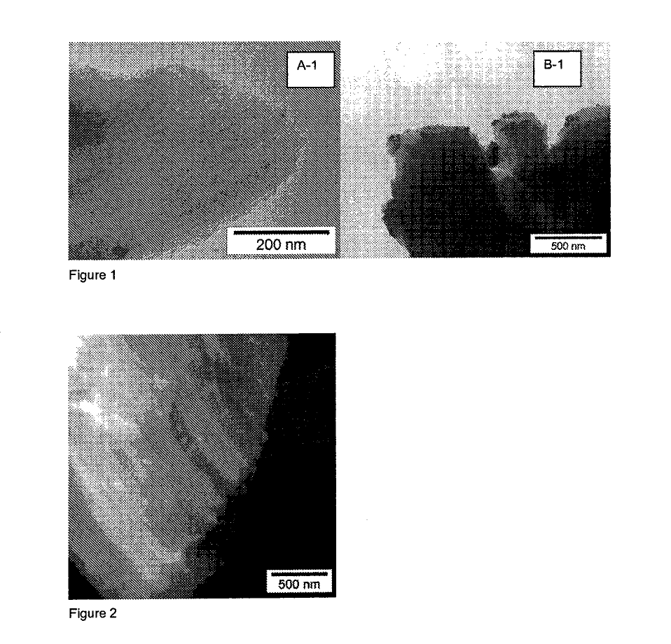

The results of the line broadening analysis are given in Table 2. Samples A-1 and A-2 were given a low temperature and high temperature thermal treatment directly after preparation. A-1 has a small average crystallite size, i.e. a high dispersion, apparent from both XRD and TEM (FIG. 1). The air treated sample (A-2) has a poor dispersion. The importance of the low temperature thermal treatment is shown by the low dispersions obtained if the sample is first dried at 120° C. in air (Sample B). Sample B-1 shows that NO (high and low temperature) thermal treatment is much less effective after drying in air at 120° C. (FIG. 1). Although sample B1 has been exposed to NO/Ar, the dispersion of the copper nitrate has been reduced by the drying step in air at 120° C. Small particles are still found inside the pores, but the agglomerates on the external surface much larger (20-400 nm). Furthermore, the average crystallite size calculated from XRD is much larger.

TABLE 2

| | Thermal Treatment | | | CuO crystallite | |
|---|---|---|---|---|---|
| | | Low | High | size | |
| | Pre- | Temperature | Temperature | d_{XRD} | |
| Sample | treatment | 25-60° C. | 60-400° C. | (nm) | d_{TEM} (nm) |
| A-1 | none | 1% NO/Ar | 1% NO/Ar | 5.5 | 2-25 |
| A-2 | none | Air | Air | 23 | Not |
| | | | | | determined |
| B-1 | Static air | 1% NO/Ar | 1% NO/Ar | 23 | 5-400 |
| | 120° C., | | | | |
| | 12 hrs | | | | |
| B-2 | Static air | Air | Air | 23 | Not |
| | 120° C., | | | | determined |
| | 12 hrs | | | | |

The results indicate that higher dispersions are obtained when the drying step in air is replaced by a low temperature thermal treatment in NO.

### Example 2

### SBA-15 Supported Copper Oxide: Low and High Temperature Thermal Treatment after Room Temperature Drying

Impregnation was performed as described in Example 1. After an equilibration time of 15 minutes the impregnated material was dried in a dessicator, containing 4 Å molecular sieves, at atmospheric temperature (25° C.) and pressure for 24 hours to remove the solvent water (typically 90% of the solvent was removed). The resulting dried material was designated sample C. A small amount of the dried material (100 mg) was subjected to a combined low and high temperature thermal treatment in 1% NO/Ar (denoted as C-1) or air (denoted as C-2) using the method and apparatus described in Example 1 (see Table 1 for conditions).

The samples were characterized by XRD. Line broadening analysis indicated that dispersions comparative to Example 1 were obtained, 4.5 nm average crystallite size for NO calcined material and 23 nm for air calcined material (C-2). The average crystallite size after NO thermal treatment (low+high) is somewhat smaller than in Example 1, which may be ascribed to the higher water content of Sample A.

These results indicate that solvent water may be removed prior to NO low temperature thermal treatment, as long as it is done at low temperatures.

### Example 3

### SBA-15 Supported Copper Oxide: Low and High Temperature Thermal Treatment after Drying at 60° C.

Impregnation was performed as described in Example 1. After 15 min of equilibration, the impregnated material was dried in static air at 60° C. for 12 hours (Sample D). After drying, a small amount of sample (100 mg) was subjected to a combined low and high temperature thermal treatment in 1% NO/Ar (denoted as D-1) or air (denoted as D-2) using the apparatus described in Example 1 (see Table 3 for conditions).

TABLE 3
Temperature and gas flow thermal treatment

| | | | | Heating | | NO/Ar/N₂* |
|---|---|---|---|---|---|---|
| | Duration | Tₛₜₐᵣₜ | T_{final} | rate | N₂ | or air |
| Step N^{o} | (min) | (° C.) | (° C.) | ° C./min | (ml/min) | (ml/min) |
| 1 | 10 | 25 | 25 | 0 | 100 | 0 |
| 2 | 75 | 25 | 400 | 5 | 0 | 100 |
| 3 | 30 | 400 | 400 | | 0 | 100 |
| 4 | 40 | 400 | 25 | −10 | 100 | 0 |

*2% v/v NO, 18% v/v Ar, 80% N₂

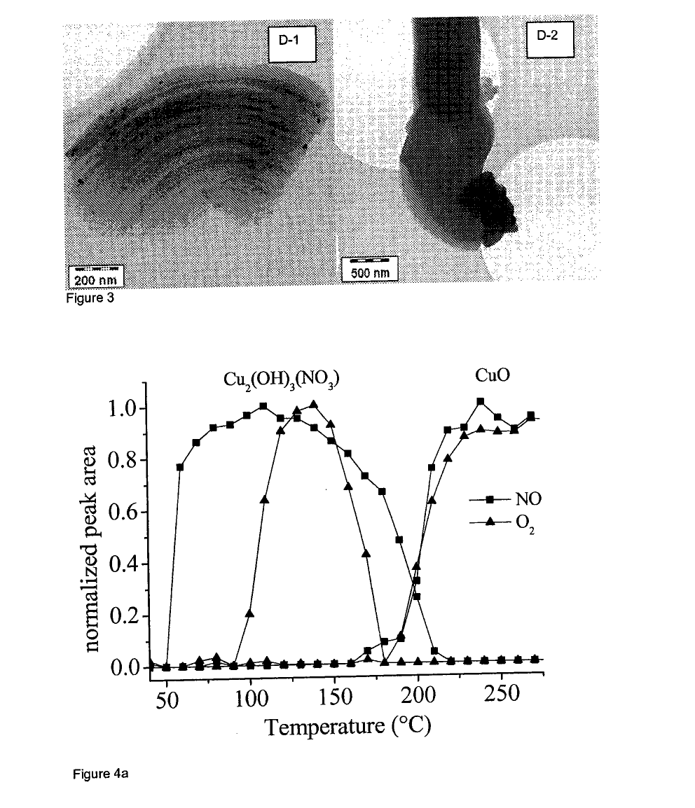

FIG. 2 indicates that the sample may be dried at 60° C., but that lower temperatures may be preferred as some agglomeration starts to occur. XRD analysis indicated an average crystallite size of 6.5 nm for D-1 and 23 nm for D2. TEM (FIG. 3) indicates that the majority of the CuO phase is highly dispersed after NO calcination (d_{TEM}=2-40 nm), whereas air calcination yields mostly extremely large agglomerates (d_{TEM}=10-500 nm).

These results indicate that higher heating rates and drying temperatures may be used, but lower temperatures and heating rates are preferred.

### Example 4

### Cu₂(OH)₃NO₃ Dispersion after Drying

In situ XRD experiments were performed with a Bruker-AXS D8 Advance X-ray Diffractometer setup using CoK_{α12} radiation. 50 mg of sample C from Example 2 was heated with a ramp of 1° C./min to 350° C. in an Anton-Paar XRK reaction chamber in a flow of 10% O₂/N₂ or 10% NO/He. The conditions are summarized in Table 4. The sample treated in 10% NO by volume in He was designated E-1 and in air E-2.

TABLE 4
Temperature and gas flow thermal treatment in situ XRD

| | | | | Heating | | *NO/He or |
|---|---|---|---|---|---|---|
| | Duration | Tₛₜₐᵣₜ | T_{final} | rate | N₂ | *O₂/N₂ |
| Step N^{o} | (min) | (° C.) | (° C.) | ° C./min | (ml/min) | (ml/min) |
| 1 | 10 | 25 | 25 | 0 | 100 | 0 |
| 2 | 325 | 25 | 350 | 1 | 0 | 100 |
| 3 | 40 | 350 | 25 | −10 | 100 | 0 |

*10% O₂/N₂ or 10% NO/He.

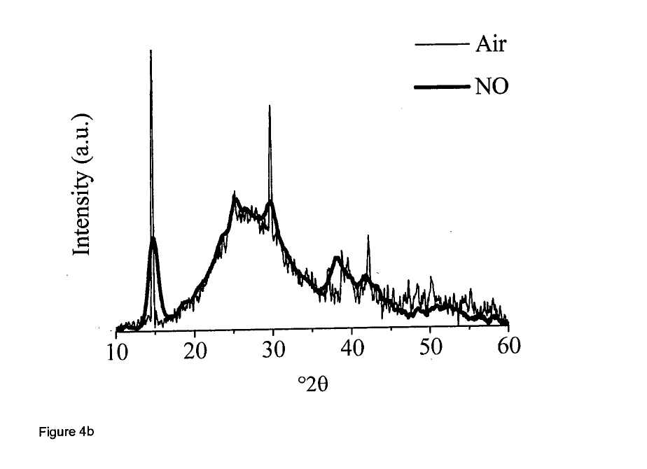

During the in situ combined low and high temperature thermal treatment in NO and O₂ only two phases were observed, Cu₂(OH)₃NO₃ and CuO. FIG. 4a depicts the normalized peak area of the Cu₂(OH)₃NO₃ and CuO diffraction lines as a function of temperature, and FIG. 4b the diffraction lines at 120° C. for both thermal treatments. Scherrer line broadening analysis indicates a 9 nm Cu₂(OH)₃NO₃ crystal domain size for low temperature treatment in NO and 23 nm for air. After full decomposition (high temperature thermal treatment), average CuO crystallites of 6 and 23 nm were obtained for the NO and air thermal treatment, respectively.

FIG. 4a clearly shows that CuO does not form in both cases until about 175° C. under these conditions, however the conversion to the copper hydroxynitrate is markedly different when NO is present compared to O₂. When NO is present the formation of the copper hydroxynitrate begins about 50° C. and reaches a peak at about 110° C., whereas with O₂, the formation begins about 90° C. and reaches a maximum about 130° C. Thus it appears that the NO is causing the formation of the copper hydroxynitrate at lower temperatures.

These experiments also indicate that that low temperature NO thermal treatment results in the formation of a highly dispersed Cu₂(OH)₃NO₃ phase, whereas thermal treatment in air yields very poor dispersions.

Moreover, the dispersion of this phase directly determines the CuO dispersion after high temperature thermal treatment to convert the copper nitrate to copper oxide.

### Example 5

### SBA-15 Supported Nickel Oxide

An incipient wetness impregnation was performed with 3.0 M aqueous nickel (II) nitrate (Ni(NO₃)₂.6H₂O) solution at 60 mbar on 0.25 g SBA-15 powder (BET surface area=600 m²/g, total pore volume=0.7 cm³/g) to provide 15 wt % Ni/SiO₂. After an equilibration time of 15 minutes the impregnated material was dried at room temperature (25° C.) in a dessicator, as described in Example 2. For comparison, another sample was dried at 120° C., as described in Example 1. The room temperature dried material was designated sample F and the 120° C. dried material, as sample G. A small amount (50 mg) of the dried sample was subjected to a combined low and high temperature thermal treatment in 10% NO/He or 20% O₂/N₂, as described in Example 4 (Table 4). The samples treated in 10% NO by volume in He were designated F-1, G-1 and in air F-2, G-2.

Samples F-1. F-2, G-1, G-2 were analyzed by XRD. The results of the line broadening analysis of the 50.8° reflection are summarized in Table 5.

TABLE 5

| | Thermal Treatment | | | |
|---|---|---|---|---|
| | | Low | High | NiO crystallite size |
| | Pretreatment | temperature | temperature | D_{XRD} (nm) |
| F-1 | Dessicator | NO/He | NO/He | 2.5 |
| | 25° C., 24 hrs | | | |
| F-2 | Dessicator | O₂/N₂ | O₂/N₂ | 10 |
| | 25° C., 24 hrs | | | |
| G-1 | Static air | NO/He | NO/He | 4 |
| | 120° C., 12 hrs | | | |
| G-2 | Static air | O₂/N₂ | O₂/N₂ | 10 |
| | 120° C., 12 hrs | | | |

The results indicate that again smaller crystallites(higher dispersions) are obtained when the air drying step at 120° C. is replaced by a low temperature thermal treatment in NO.

### Example 6

### Use of N₂O in Place of NO for Low-Temperature Treatment

Samples A (Example 1), F and G (Example 5) were subjected to a combined low and high temperature thermal treatment in 1% N₂O v/v in He, or 1% NO/He. The thermal treatment was performed inside a HVC-DRP-3 Diffuse Reflectance Reaction Chamber (supplied by Harrick) as part of a mechanistic IR study. The cell was constructed such that it operates under plug-flow conditions. All air and NO treatments that were performed yielded similar dispersions to ex situ experiments. Typically 10 mg of sample was loaded and heated with 1° C./min to 350° C. in a flow of 1% NO/He or 1% N₂O/He. The details of the thermal treatment are given in Table 6.

TABLE 6
Temperature and gas flow thermal treatment in situ XRD

| | | | | Heating | | NO/He* or |
|---|---|---|---|---|---|---|
| | Duration | Tₛₜₐᵣₜ | T_{final} | rate | N₂ | N₂O/He** |
| Step N^{o} | (min) | (° C.) | (° C.) | ° C./min | (ml/min) | (ml/min) |
| 1 | 10 | 25 | 25 | 0 | 10 | 0 |
| 2 | 325 | 25 | 350 | 1 | 0 | 10 |
| 3 | 40 | 350 | 25 | −10 | 10 | 0 |

*1% v/v NO/He.
**1% v/v N₂O/He

IR studies indicated that very little or no Cu₂(OH)₃NO₃ (Sample A) or Ni₃(OH)₄(NO₃)₂ (Sample F) was formed during low temperature thermal treatment (25-120° C.) in N₂O, whereas clear formation of these compounds was observed in NO. XRD analysis after high temperature treatment indicated N₂O failed to prevent agglomeration, whereas high dispersions were obtained after NO treatment (Table 7). Sample G was dried in air for 12 hours and thus had already partly decomposed into Ni₃(OH)₄(NO₃)₂. Table 7 shows that here N₂O and NO yielded comparable results.

TABLE 7

| | | Gas composition | |
|---|---|---|---|
| | | (low and high | Crystallite |
| | | temperature) | size |
| Sample | Pre-treatment | thermal treatment | d_{XRD} (nm) |
| A | Dessicator 25° C., | NO | 6 |
| | 24 hrs | | |
| A | Dessicator 25° C., | N₂O | 26 |
| | 24 hrs | | |
| F-1 | Dessicator 25° C., | NO | 3 |
| | 24 hrs | | |
| F-2 | Dessicator 25° C., | N₂O | 10 |
| | 24 hrs | | |
| G-1 | Dried at 120° C., | NO | 4 |
| | static air | | |
| G-2 | Dried 120° C., | N₂O | 4 |
| | static air | | |

The results indicate that N₂O is ineffective in the low temperature thermal treatment of both copper and nickel nitrate, whereas NO is. The difference between the two gasses indicates the difference between low and high temperature thermal treatment.

### Example 7

### SBA-supported Cobalt Oxide: Low Temperature NO Thermal Treatment Combined with High Temperature Air Thermal Treatment

An incipient wetness impregnation step was performed using 3.0M aqueous cobalt (II) nitrate (Co(NO₃)₂.6H₂O) solution on 0.25 g SBA-15 powder (BET surface area=600 m²/g, total pore volume=0.7 cm³/g) to provide 13 wt % Co/SiO₂. After an equilibration time of 15 minutes the impregnated material (denoted as Sample H) was dried in a dessicator at room temperature for 24 hrs, as described in Example 2.

A small quantity (10 mg) of sample H was subjected to a low temperature thermal treatment in 10% NO/He, followed by a high temperature thermal treatment in 20% O₂/N₂ inside the HVC-DRP-3 Diffuse Reflectance Reaction Chamber used for Example 6. The details of the thermal treatment are given in Table 8. The thermally treated material was designated as sample H-1.

For comparison combined low and high temperature thermal treatments were performed in 10% NO/He (Sample H-2) and 20% O/N₂ (Sample H-3) using the thermal treatment set out in Table 4.

TABLE 8
Temperature and gas flow thermal treatment

| | | | | Heating | | |
|---|---|---|---|---|---|---|
| | Duration | Tₛₜₐᵣₜ | T_{final} | rate | | Flow rate |
| Step N^{o} | (min) | (° C.) | (° C.) | ° C./min | Gas | (ml/min) |
| 1 | 10 | 25 | 25 | 0 | N₂ | 0 |
| 2 | 95 | 25 | 120 | 1 | 10% NO/He | 10 |
| 3 | 5 | 120 | 120 | 0 | N₂ | 10 |
| 4 | 230 | 120 | 350 | 1 | 20% O₂/N₂ | 10 |
| 5 | 32 | 350 | 25 | −10 | 20% O₂/N₂ | 10 |

The results of XRD line broadening analysis of the of the most intense diffraction line of the resulting CO₃O₄ phase (43.1° 2θ) are summarized in Table 9.

TABLE 9

| | Gas composition thermal treatment | | | Crystallite |
|---|---|---|---|---|
| | | | High | size |
| Sample | Pre-treatment | Low temperature | temperature | d_{XRD} (nm) |
| H-1 | Dessicator | 10% NO/He | 20% O₂/N₂ | 6 |
| | 25° C., 24 hrs | | | |
| H-2 | Dessicator | 10% NO/He | 10% NO/He | 4.5 |
| | 25° C., 24 hrs | | | |
| H-3 | Dessicator | 20% O₂/N₂ | 20% O₂/N₂ | 10 |
| | 25° C., 24 hrs | | | |

The results demonstrate that low temperature thermal treatment in NO, results in a higher dispersion even after high temperature calcination in O₂/N₂.

### Example 8

### SBA-Supported Nickel Oxide: Low Temperature NO Thermal Treatment Combined with High Temperature Stagnant Thermal Treatment

An incipient wetness impregnation step was performed using 4.3M aqueous nickel (II) nitrate (Ni(NO₃)₂.6H₂O) solution on 1 g SBA-15 powder (BET surface area=600 m²/g, total pore volume=0.8 cm³/g) to provide 15 wt % Ni/SiO₂. After an equilibration time of 15 minutes the impregnated material (denoted as Sample I) was divided in three parts and given different low temperature thermal treatments. A first sample was transferred to a ceramic crucible and heated in a muffle oven in static air to 150° C. with a ramp of 2° C./min and maintained at this temperature for 16 hrs (sample I-1). The other two samples were transferred to a plug flow reactor (see Example 1) and given a low temperature thermal treatment in N₂ (sample 1-2) or 10% NO/He (sample I-3) as described in Table 10. After the low temperature thermal treatments all samples were transferred to crucibles for high temperature thermal treatment in static air in a muffle oven (see Table 10 for details).

TABLE 10
Temperature and gas flow thermal treatments

| | | | | | | |
|---|---|---|---|---|---|---|
| | | | | Heating | | |
| Step | Duration | Tₛₜₐᵣₜ | T_{final} | rate | | GHSV |
| N^{o} | (min) | (° C.) | (° C.) | ° C./min | Gas | (h⁻¹) |

Low temperature thermal treatments (used for samples I-2 and I-3)

| | | | | | | |
|---|---|---|---|---|---|---|
| 1 | 10 | 25 | 25 | 0 | N₂ | 3000 |
| 2 | 63 | 25 | 150 | 2 | N₂ (I-2) or | 3000 |
| | | | | | 10% NO/He (I-3) | |
| 3 | 180 | 150 | 150 | 0 | N₂ (I-2) or | 3000 |
| | | | | | 10% NO/He (I-3) | |
| 4 | 25 | 150 | 25 | −5 | N₂ | 3000 |

High temperature thermal treatment (used for samples I-1, I-2, I-3)

| | | | | | | |
|---|---|---|---|---|---|---|
| 5 | 163 | 25 | 350 | 2 | Air | 0 |
| 6 | 60 | 350 | 350 | 2 | Air | 0 |
| | 33 | 350 | 25 | −10 | Air | 0 |

The results of XRD line broadening analysis of the of the most intense diffraction line of the resulting NiO phase (50.8° 2θ) are summarized in Table 11.

TABLE 11

| | Gas composition thermal treatment | | |
|---|---|---|---|
| | | High | Crystallite size |
| Sample | Low temperature | temperature | d_{XRD} (nm) |
| I-1 | Static air, 150° C., 16 hrs | Static air | 15 |
| I-2 | N₂, 150° C., 3 hrs | Static air | 32 |
| I-3 | 10% NO, 150° C., 3 hrs | Static air | 9 |

The results demonstrate that low temperature thermal treatment in NO, results in a higher dispersion even after high temperature calcination in static air.

1. A method for the preparation of a supported metal oxide, suitable as a precursor for a catalyst or sorbent, comprising the steps of:
(i) impregnating a support material with a metal nitrate,
(ii) exposing the impregnated material to a gas mixture comprising nitric oxide at a temperature in the range 0-150° C., to form a dispersed supported metal nitrate, and
(iii) calcining the metal nitrate to effect its decomposition and form a supported metal oxide, wherein the calcination is performed under a gas mixture that contains nitric oxide, nitrous oxide or a mixture thereof and has an oxygen content of ≦5% by volume.

2. A method according to claim 1, wherein the metal nitrate comprises a transition metal nitrate.

3. A method according to claim 2 wherein the dispersed supported metal nitrate comprises a metal nitrate of formula Mₓ(OH)_{y}(NO₃)_{z} in which x, y and z are integers ≧1 and M is a transition metal.

4. A method according to claim 1, wherein the support is a metal, carbon, metal oxide, mixed metal oxide or solid polymer support.

5. A method according to claim 1, wherein the support is selected from the group consisting of alumina, metal-aluminate, silica, aluminosilicate, zinc oxide, titania, zirconia and mixtures of these.

6. A method according to claim 1, wherein the gas mixture for exposing the impregnated material has an oxygen (O₂) content ≦5% by volume.

7. A method according to claim 1, wherein the gas mixture for exposing the impregnated material consists of one or more inert gases and nitric oxide.

8. A method according to claim 7, wherein the inert gas is selected from the group consisting of nitrogen, helium and argon.

9. A method according to claim 1, wherein the nitric oxide concentration in the gas mixture for exposing the impregnated material is in the range 0.001 to 15% by volume.

10. A method according to claim 1, wherein the impregnated material is exposed to the nitric oxide-containing gas mixture at a temperature in the range 10-120° C.

11. A method according to claim 1, further comprising a step of drying the impregnated material under vacuum, air or an inert gas at a temperature below 60° C., before exposing the metal nitrate to the nitric oxide-containing gas mixture.

12. (canceled)

13. (canceled)

14. A method according to claim 1, wherein the supported metal oxide is a reducible metal oxide, further comprising a step of heating the supported metal oxide under a reducing gas stream containing a reductant selected from the group consisting of carbon monoxide, hydrogen, and mixtures thereof to effect reduction of at least a part of the metal oxide.

15. (canceled)

16. (canceled)

17. A supported oxide obtainable by the method of claim 1.

18. A supported reduced metal oxide obtainable by the method of claim 14.

19. A method according to claim 2 wherein the dispersed supported metal nitrate comprises a metal nitrate of formula Mₓ(OH)_{y}(NO₃)_{z} in which x, y and z are integers ≧1 and M is iron, ruthenium, cobalt, rhodium, iridium, nickel, palladium, platinum, copper or a mixture thereof.

20. A method according to claim 2 wherein the dispersed supported metal nitrate comprises a metal nitrate of formula Mₓ(OH)_{y}(NO₃)_{z} in which x, y and z are integers ≧1 and M is copper, nickel or cobalt.

21. A method according to claim 2 wherein the dispersed supported metal nitrate comprises a metal nitrate of formula Mₓ(OH)_{y}(NO₃)_{z} in which x, y and z are integers ≧1 and M is copper.

22. A method according to claim 1, wherein the impregnated material is exposed to the nitric oxide-containing gas mixture at a temperature in the range 25-75° C.
